(19) United States
(12) Patent Application Publication
(10) Pub. No.: US 2025/0379948 A1
(43) Pub. Date: Dec. 11, 2025

(54) HOLDING BRACKET AND IMAGE FORMING APPARATUS

(71) Applicants: Hiroki Ishimitsu, Kanagawa (JP); Masafumi Kishi, Kanagawa (JP)

(72) Inventors: Hiroki Ishimitsu, Kanagawa (JP); Masafumi Kishi, Kanagawa (JP)

(73) Assignee: Ricoh Company, Ltd., Tokyo (JP)

(21) Appl. No.: 19/210,011

(22) Filed: May 16, 2025

(30) Foreign Application Priority Data
Jun. 11, 2024 (JP) 2024-094378

(51) Int. Cl. H04N 1/00; G03G 15/22

(52) U.S. Cl. CPC H04N 1/00559; G03G 15/228; H04N 1/00557

(57) ABSTRACT

A holding bracket includes a terminal mount, an insertion portion, a first abutment, and a second abutment. A connection terminal is mounted to the terminal mount. The insertion portion is inserted into a through hole of the fixed member in an insertion direction from an outer face to an inner face of the fixed member. The first abutment is disposed at a tip of the insertion portion to abut against the inner face of the fixed member. The second abutment abuts against the outer face of the fixed member. An abutment of the first abutment and the second abutment against the fixed member attaches the holding bracket to the fixed member.

### CROSS-REFERENCE TO RELATED APPLICATIONS

This patent application is based on and claims priority pursuant to 35 U.S.C. § 119(a) to Japanese Patent Application No. 2024-094378, filed on Jun. 11, 2024, in the Japan Patent Office, the entire disclosure of which is hereby incorporated by reference herein.

### BACKGROUND

### Technical Field

The present disclosure relates to a holding bracket and an image forming apparatus.

### Related Art

The holding bracket holds a connection terminal to connect an external device and is attached to a fixed member.

### SUMMARY

The present disclosure described herein provides a holding bracket including a terminal mount, an insertion portion, a first abutment, and a second abutment. A connection terminal is mounted to the terminal mount. The insertion portion is inserted into a through hole of the fixed member in an insertion direction from an outer face to an inner face of the fixed member. The first abutment is disposed at a tip of the insertion portion to abut against the inner face of the fixed member. The second abutment abuts against the outer face of the fixed member. An abutment of the first abutment and the second abutment against the fixed member attaches the holding bracket to the fixed member.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a perspective view of a scanner frame of a scanner and a holding bracket holding a USB female terminal;

FIG. 3 is a perspective view of the holding bracket of FIG. 2 attached to the scanner frame of FIG. 2 to illustrate a part around the holding bracket;

FIG. 4 is an enlarged perspective view of a part of the holding bracket of FIG. 2;

FIG. 5 is a front view of a through hole in a front plate of the scanner frame of FIG. 2;

FIG. 6 is a front view of a part of the holding bracket of FIG. 2 and the scanner frame of FIG. 2 to illustrate a positional relationship between outer abutments, a terminal mount, and an inner abutment;

FIG. 7 is an enlarged top view of a part of the holding bracket of FIG. 2 and a part of the front plate of FIG. 5 to illustrate a dimensional relationship of inner abutment and outer abutments;

FIG. 8 is a perspective view of the inner abutment of FIG. 7 that abuts against the front plate of FIG. 7;

FIG. 9 is an enlarged top view of the holding bracket of FIG. 7 elastically deformed after the holding bracket is attached to the front plate of FIG. 7; and

FIGS. 10A and 10B are schematic plan views of a holding bracket in a modification and a part of a front plate.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings illustrating the following embodiments, like reference signs are allocated to elements having the same function or shape and redundant descriptions thereof are omitted below.

The following describes the holding bracket and the image forming apparatus with reference to the accompanying drawings.

The image forming apparatus to which the holding bracket is attached is described below.

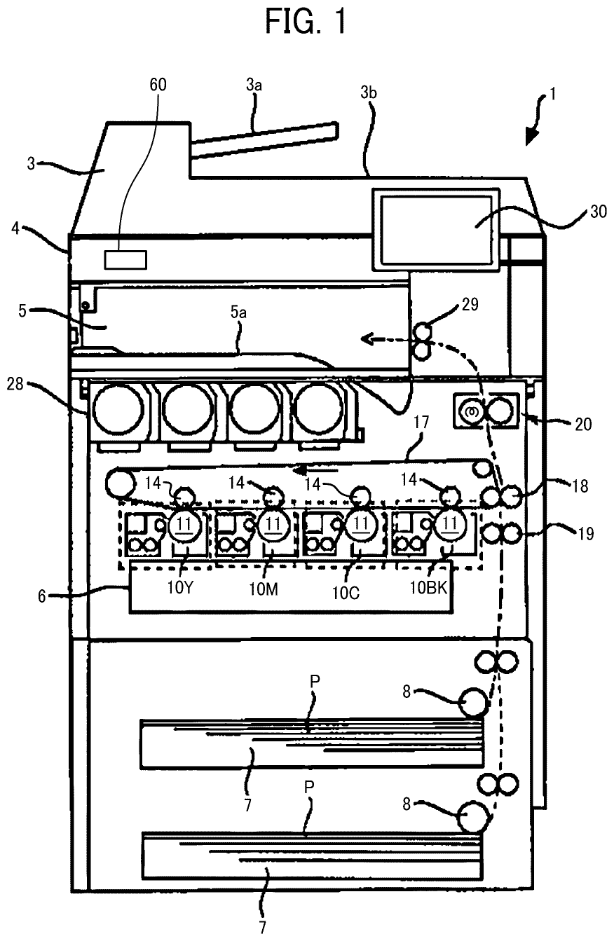

FIG. 1 is a schematic diagram illustrating a configuration of an image forming apparatus 1.

The image forming apparatus 1 is a tandem-type color copier. The image forming apparatus 1 includes a document feeder 3, a scanner 4, an in-body sheet ejection section (an in-body opening unit) 5, and an exposure device 6. The image forming device 1 further includes a sheet feeder 7 including a sheet feeding tray, and image forming units 10Y, 10M, 10C, and 10BK corresponding to respective colors (yellow, magenta, cyan, and black). The image forming apparatus 1 further includes an intermediate transfer belt 17, a secondary transfer roller 18, a fixing device 20, toner containers 28, and a control panel 30.

The document feeder 3 conveys a document set on a document setting portion (a document table) 3a to the scanner 4 and ejects the document to a document ejection portion 3b. The scanner 4 reads the image data of the document.

The exposure device 6 emits laser light beams based on the image data. The sheet feeding tray in the sheet feeder 7 stores sheets P that are sheets of paper. Multiple color toner images are transferred to and superimposed on the intermediate transfer belt 17 to form a color toner image. The color toner image formed on the intermediate transfer belt 17 is transferred to the sheet P by the secondary transfer roller 18.

The color toner image transferred to the sheet P is not fixed, which is referred to as an unfixed image. The fixing device 20 fixes the unfixed image onto the sheet P. The toner containers 28 store color toners that are supplied to the developing devices disposed in the image forming units 10Y, 10M, 10C, and 10BK, respectively. The control panel 30 displays information relating to printing operations (image forming operations) and allows a user to perform operations relating to the printing operation.

Inside the body of the image forming apparatus 1, the four image forming units 10Y, 10M, 10C, and 10BK are arranged side by side so as to face the intermediate transfer belt 17. A driving mechanism rotates the intermediate transfer belt 17 in a predetermined direction that is the direction indicated by the arrow in FIG. 1, the counterclockwise direction.

At least a front side of the body of the image forming apparatus 1 is opened to form the in-body sheet ejection section 5. After the color toner image is formed on the sheet P, the sheet P is ejected from the body of the image forming apparatus 1 and stacked on a sheet ejection face 5a.

Below the in-body sheet ejection section 5, an image forming section is disposed. The image forming section includes the image forming units 10Y, 10M, 10C, and 10BK, the intermediate transfer belt 17, the exposure device 6, the sheet feeder 7, and the fixing device 20. The scanner 4 and the document feeder 3 are disposed above the in-body sheet ejection section 5.

A description is given below of typical image forming processes of the image forming apparatus 1 to form the color toner image on the sheet P.

The document is set on the document setting portion (the document table) 3a, fed into the document feeder 3 by a feeding roller, conveyed by conveying rollers, and placed on a platen of the scanner 4. The scanner 4 optically reads the image data of the document placed on the platen.

The scanner 4 irradiates the image of the document on the platen with light emitted from a light source (e.g., a lamp), thereby scanning the image of the document. The light reflected from the surface of the document is imaged on a color sensor via mirrors and lenses. The multicolor image data of the document is read for each color separation light of red, green, and blue (RGB) by the color sensor and converted into electrical image signals. Further, the image signals are transmitted to an image processor that performs image processing (e.g., color conversion, color calibration, and spatial frequency adjustment) according to the color separation image signals of RGB, and thus, image data of yellow, magenta, cyan, and black are obtained.

After the scanner 4 reads the image data of the document, the conveyance roller conveys the document from the position of the scanner to an ejection port of the document feeder 3 and ejects the document from the ejection port. The document ejected from the ejection port is stacked on an ejected face of the document ejection portion 3b.

The yellow, magenta, cyan, and black image data read by the scanner 4 are transmitted to the exposure device 6. The exposure device 6 emits laser beams (e.g., exposure light) onto the surfaces of photoconductor drums 11 in the image forming units 10Y, 10M, 10C, and 10BK according to the image data of yellow, magenta, cyan, and black, respectively.

The photoconductor drums 11 in the image forming units 10Y, 10M, 10C, and 10BK rotate clockwise in FIG. 1. The surface of the photoconductor drum 11 is uniformly charged at a position where the photoconductor drum 11 faces a charging roller, which is referred to as a charging process. Thus, the surface of the photoconductor drum 11 is charged to a certain potential.

Subsequently, the surface of each of the photoconductor drums 11 thus charged reaches a position in which the surface of each of the photoconductor drums 11 is irradiated with the laser beam. A light source in the exposure device 6 emits the laser beam corresponding to the image data of each color. The laser beam emitted from the light source of the exposure device 6 is incident on a polygon mirror, reflected by the polygon mirror, and then passes through multiple lenses. After the respective laser beams L corresponding to four colors pass through multiple lenses, the respective laser beams pass through different optical paths for components of yellow, magenta, cyan, and black and are emitted from the emission windows corresponding to color components in the exposure device 6.

For example, the surface of the photoconductor drum 11 in the leftmost image forming unit 10Y in FIG. 1 (in other words, the image forming unit 10Y upstream from other image forming units in a surface moving direction of the intermediate transfer belt 17) is irradiated with a laser beam corresponding to the image data of yellow. At that time, the polygon mirror rotates at high speed to deflect the laser beam for the yellow component in an axial direction of rotation of the photoconductor drum 11 (i.e., the main scanning direction) so that the laser beam scans the photoconductor drum 11. Thus, an electrostatic latent image corresponding to the yellow image data is formed on the photoconductor drum 11 charged by the charging roller (an exposure process).

Similarly, the laser beam for the magenta component is directed to the surface of the photoconductor drum 11 of the image forming unit 10M that is the second from the left in FIG. 1 (in other words, the image forming unit 10M that is the second from the point upstream from image forming units in the surface moving direction of the intermediate transfer belt 17), thus forming an electrostatic latent image for magenta thereon. The laser beam for the cyan component is directed to the surface of the photoconductor drum 11 of the image forming unit 10C that is the third from the left in FIG. 1 (in other words, the image forming unit 10C that is the third from the point upstream from image forming units in the surface moving direction of the intermediate transfer belt 17), thus forming an electrostatic latent image for cyan thereon. The laser beam for the black component is directed to the surface of the photoconductor drum 11 of the image forming unit 10BK that is the fourth from the left in FIG. 1 (in other words, the image forming unit 10BK that is the fourth from the point upstream from image forming units in the surface moving direction of the intermediate transfer belt 17), thus forming an electrostatic latent image for black thereon.

The surface of the photoconductor drum 11 carrying the electrostatic latent image reaches a position opposite the developing device. The developing device supplies toner onto the surface of the photoconductor drum 11 and develops the electrostatic latent image on the photoconductor drum 11 into a toner image, which is referred to as a developing process.

After the developing process, the surface of the photoconductor drum 11 reaches a position opposite the intermediate transfer belt 17. At positions facing the photoconductor drums 11 via the intermediate transfer belt 17, primary transfer rollers 14 are disposed in contact with an inner circumferential face of the intermediate transfer belt 17. At the positions of the primary transfer rollers 14, the toner images on the photoconductor drums 11 are sequentially transferred to and superimposed on the intermediate transfer belt 17, forming a multicolor toner image thereon, which is referred to as a primary transfer process.

After the primary transfer process, the surface of the photoconductor drum 11 reaches a position opposite the cleaning device. The cleaning device collects untransferred toner remaining on the photoconductor drum 11, which is referred to as a cleaning process. After the cleaning process, each of the surfaces of the photoconductor drums 11 passes through the position of a charge remover, and a series of image forming process on the photoconductor drums 11 is completed.

The surface of the intermediate transfer belt 17, onto which the single-color toner images on the photoconductor drums 11 are superimposed, moves in the direction indicated by arrow in FIG. 1 and reaches a position opposite the secondary transfer roller 18. The secondary transfer roller 18 secondarily transfers the multicolor toner image on the intermediate transfer belt 17 to the sheet P, which is referred to as a secondary transfer process.

After the secondary transfer process, the outer circumferential surface of the intermediate transfer belt 17 reaches a cleaning position opposite an intermediate transfer belt cleaner. The intermediate transfer belt cleaner collects the untransferred toner on the intermediate transfer belt 17 to complete a series of transfer processes on the intermediate transfer belt 17.

The sheet P is conveyed to the position of the secondary transfer roller 18 via a conveyance guide and a registration roller pair 19 from the sheet feeder 7. Specifically, a sheet feeding roller 8 feeds the sheet from the sheet feeder 7 that stores multiple sheets, and the sheet is then guided by a conveyance guide to the registration roller pair 19 (i.e., a timing roller pair). The sheet P that has reached the registration roller pair 19 is conveyed toward the position of the secondary transfer roller 18, timed to coincide with the arrival of the multicolor toner image on the intermediate transfer belt 17.

The multicolor toner image is transferred onto the sheet at the position of the secondary transfer roller 18, and the sheet is conveyed to the fixing device 20. The fixing device 20 includes a fixing roller and a pressure roller pressing against each other. In a nip between the fixing roller and the pressure roller, the multicolor toner image is fixed on the sheet P. After a fixing process, an output roller pair 29 ejects the sheet P as an output image to the exterior of the image forming apparatus, and the ejected sheet P is stacked on the sheet ejection face 5a in the in-body sheet ejection section 5 to complete a series of image forming processes.

The image forming apparatus 1 includes a control panel 30 on a part of the front side of the scanner 4 and a universal serial bus (USB) port 60 on the other part of the front side of the scanner 4 (that is, the left part of the scanner 4 in FIG. 1). A USB male terminal as an external terminal is inserted into the USB port 60.

The USB port 60 used by the user is desired to have accessibility so as to be easily operated. On the front side of the body of the image forming apparatus 1, the image forming section is disposed below the in-body sheet ejection section 5. The image forming section includes parts to form the image and has no space to place the USB port 60. As a result, the USB port 60 is typically on the scanner 4, the document feeder 3, or the control panel 30.

However, various models of the image forming apparatus 1 are likely to include different document feeders 3 or different control panels 30. As a result, the USB port 60 according to the present embodiment is disposed on the scanner 4 to enhance the accessibility. The USB port 60 on the scanner 4 can be installed in the various models including a model without the document feeder 3.

To place the USB port 60 on the scanner 4, a holding bracket holding a USB female terminal as a connection terminal is typically fastened to a front plate of a scanner frame of the scanner 4 with screws. Fastening the holding bracket to the scanner frame with screws enables the holding bracket to be attached to the scanner frame without rattling and gives an advantage that the quality feeling can be enhanced.

To fasten the holding bracket to the scanner frame with screws, a screw groove is formed by tapping on an inner peripheral surface of a through hole formed by punching or laser processing on a front plate made of a sheet metal of the scanner frame. Forming the screw groove generates cutting powder. After the screw groove is formed, a removal process is performed by air blowing to remove the cutting powder, but the cutting powder may not be completely removed in the removal process and may remain. The cutting powder remaining on the front plate of the scanner frame enters the inside of the scanner frame and adheres to optical components arranged inside the scanner frame, which may affect the reading performance of the scanner 4. In particular, when a design change is made to add the USB port 60 to an image forming apparatus in mass production, a method of removing the cutting powder and a method of detecting adhesion of the cutting powder are considered to maintain the reading performance, which greatly affects the cost and schedule. To avoid the above-described disadvantages, for example, using a double-sided adhesive tape to fix a holding bracket 42 to a scanner frame 41 may be considered. However, when the USB male terminal of the external device is inserted and removed, the holding bracket 42 is shaken, which causes the quality feeling to be poor.

A structure according to the present embodiment can attach the holding bracket 42 to the scanner frame 41 without rattling and without using the screw. A detailed description is now given of the structure according to the present embodiment, with reference to the drawings.

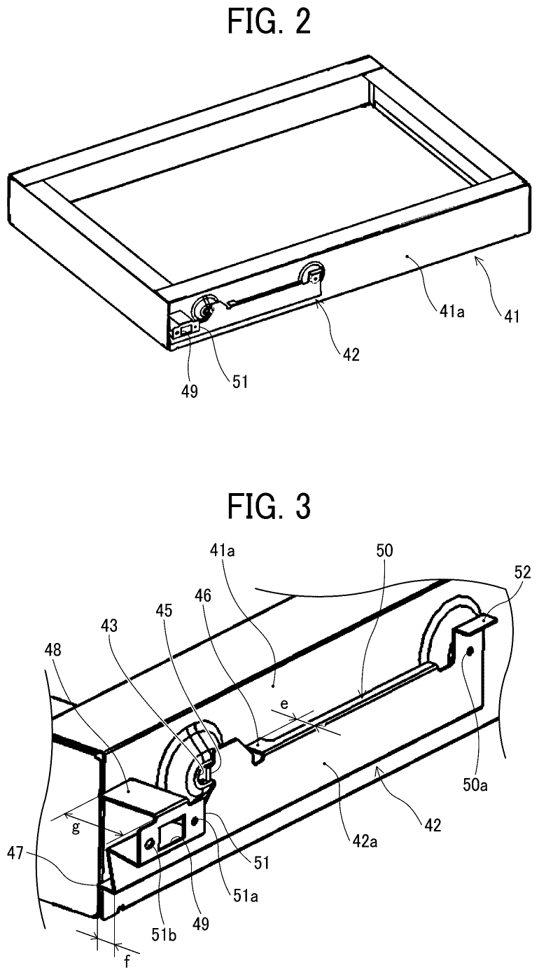

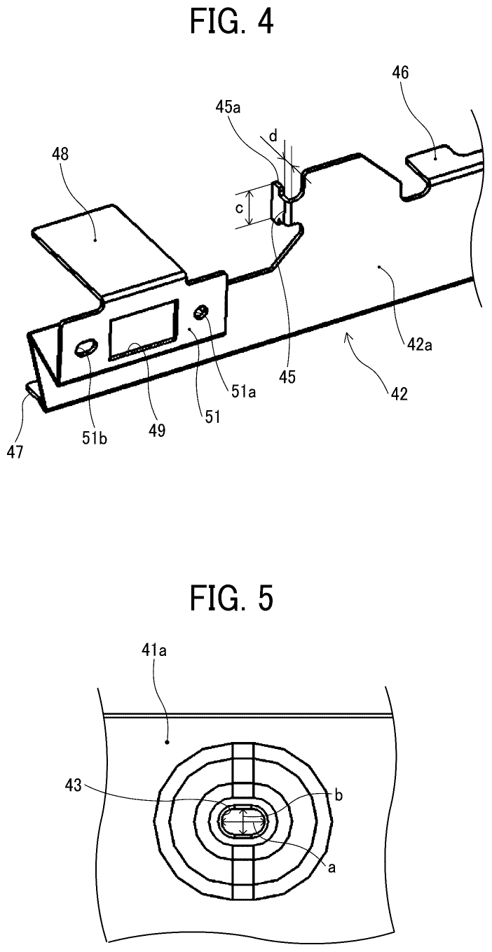

FIG. 2 is a perspective view of the scanner frame 41 of the scanner 4 and the holding bracket 42 holding the USB female terminal as the connection terminal. FIG. 3 is a perspective view of the holding bracket 42 attached to the scanner frame 41 to illustrate a part around the holding bracket 42. FIG. 4 is an enlarged perspective view of a part of the holding bracket 42.

As illustrated in FIG. 2, the holding bracket 42 made of a sheet metal includes a terminal mount 51 to which the USB female terminal is mounted. The scanner frame 41 as a fixed member includes a front plate 41a made of a sheet metal. The holding bracket 42 is attached to the front plate 41a.

As illustrated in FIGS. 3 and 4, the holding bracket 42 has a port opening 49 at the center of the terminal mount 51 and through holes 51a and 51b formed at both sides of the port opening. Screws are inserted into the through holes 51a and 51b, and the USB female terminal is fixed on the holding bracket 42 by the screws. Fastening the USB female terminal to the terminal mount 51 by a screw positions the insertion port of the USB female terminal in the port opening 49.

The holding bracket 42 includes an insertion portion 45 and three outer abutments 46, 47, and 48 that are a first outer abutment 46, a second outer abutment 47, and a third outer abutment 48. The three outer abutments 46, 47, and 48 serve as second abutments and abut against the outer face of the front plate 41a of the scanner frame 41. In other words, the three second abutments have second portions abutting against the outer face of the scanner frame 41 as the fixed member. The insertion portion 45 is inserted into a through hole 43 in the front plate 41a in an insertion direction from the outer face to an inner face of the scanner frame 41 as the fixed member. The holding bracket 42 includes an extension portion 50 extending toward the right side in FIG. 3. The holding bracket 42 has a screw hole 50a and a push-in portion 52 as an operation portion that are in an end part of the extension portion 50.

Bending a body 42a of the holding bracket 42 by 90 degrees toward the back side of the image forming apparatus forms the three outer abutments 46, 47, and 48 and the insertion portion 45. In other words, the insertion portion 45 and the outer abutment as the second abutment protrude from the body 42a in the insertion direction. Bending the extension portion 50 by 90 degrees toward the front side of the image forming apparatus forms the push-in portion 52. A worker uses the push-in portion 52 to push the holding bracket 42 when the worker rotates the holding bracket 42 and attaches the holding bracket 42 to the scanner frame 41, which is described below.

As illustrated in FIG. 4, the holding bracket 42 includes an inner abutment 45a as a first abutment at the tip of the insertion portion 45. The inner abutment 45a protrudes from the insertion portion 45 in the vertical direction in FIG. 4. The inner abutment 45a as the first abutment has a portion as a first portion abutting against the inner face of the scanner frame 41 as the fixed member. As illustrated in FIG. 5, the through hole 43 in the front plate 41a has a long hole shape extending in the lateral direction of the image forming apparatus. A length a of the through hole 43 in the lateral direction, which is the longitudinal direction of the through hole 43, is longer than a length c of the inner abutment 45a illustrated in FIG. 4. A length b (see FIG. 5) of the through hole 43 in the vertical direction, which is the short-side direction of the through hole 43, is shorter than the length c. In other words, the through hole has the long hole shape having a first length such as the length a in the longitudinal direction and a second length such as the length b in the short-side direction of the long hole shape, and the inner abutment 45a as the first abutment protrudes from the tip of the insertion portion in the short-side direction orthogonal to the insertion direction and the longitudinal direction and has a third length such as the length c shorter than the length a and longer than the length b.

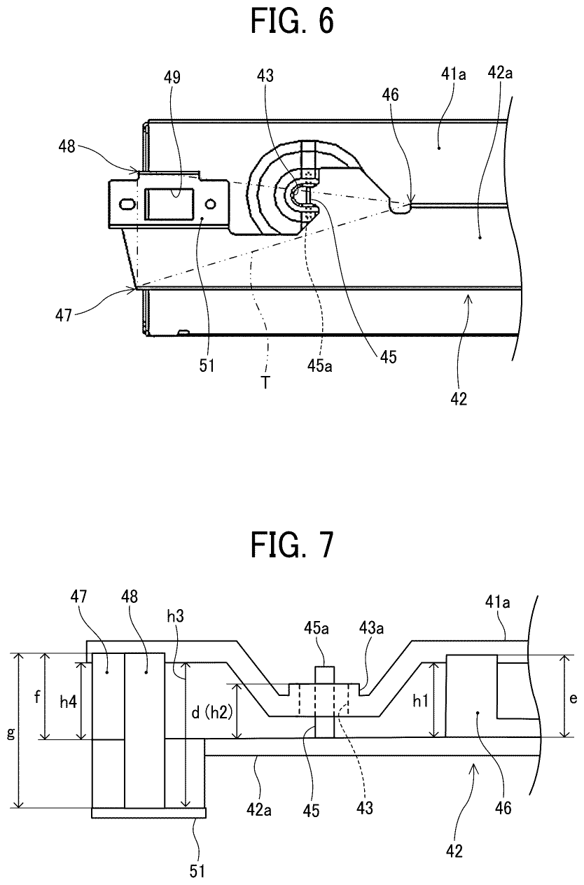

As illustrated in FIG. 6, a half or more region of the terminal mount 51 is within a triangle T formed by connecting the three outer abutments 46, 47, and 48 when the holding bracket 42 is viewed from the front side. In addition, the inner abutment 45a abuts against the front plate 41a at two abutment positions, and one of the two abutment positions is within the triangle T. In other words, the first portion and a half or more region of the terminal mount 51 are disposed within the triangle T as a polygonal region formed by connecting positions of the second portions when viewing the outer face of the scanner frame 41 from the insertion direction.

FIG. 7 is an enlarged top view of a part of the holding bracket 42 and a part of the front plate 41a to illustrate a dimensional relationship of inner abutment and outer abutments.

As illustrated in FIG. 7, the first outer abutment 46 protrudes from the body 42a of the holding bracket 42 by a length (in other words, a height) e. After the holding bracket 42 is attached to the front plate 41a, the first outer abutment 46 abuts against a first outer face of the front plate 41a. The body 42a of the holding bracket 42 has a first inner face facing the first outer face of the front plate 41a. The first outer abutment 46 is between the first outer face of the front plate 41a and the first inner face of the body 42a of the holding bracket 42. As illustrated in FIG. 7, the length (the height) e is longer than a distance h1 from the first outer face of the front plate 41a to the first inner face of the body 42a of the holding bracket 42.

The second outer abutment 47 protrudes from the body 42a of the holding bracket 42 by a length (in other words, a height) f. After the holding bracket 42 is attached to the front plate 41a, the second outer abutment 47 abuts against a second outer face of the front plate 41a. The body 42a of the holding bracket 42 has a second inner face facing the second outer face of the front plate 41a. The second outer abutment 47 is between the second outer face of the front plate 41a and the second inner face of the body 42a of the holding bracket 42. As illustrated in FIG. 7, the length (the height) f is longer than a distance h4 from the second outer face of the front plate 41a to the second inner face of the body 42a of the holding bracket 42.

The third outer abutment 48 protrudes from the terminal mount 51 by a length (in other words, a height) g. After the holding bracket 42 is attached to the front plate 41a, the third outer abutment 48 abuts against a third outer face of the front plate 41a. The terminal mount 51 has a third inner face facing the third outer face. The third outer abutment 48 is between the third outer face of the front plate 41a and the third inner face of the terminal mount 51. As illustrated in FIG. 7, the length (the height) g is longer than a distance h3 from the third outer face of the front plate 41a to the third inner face of the terminal mount 51.

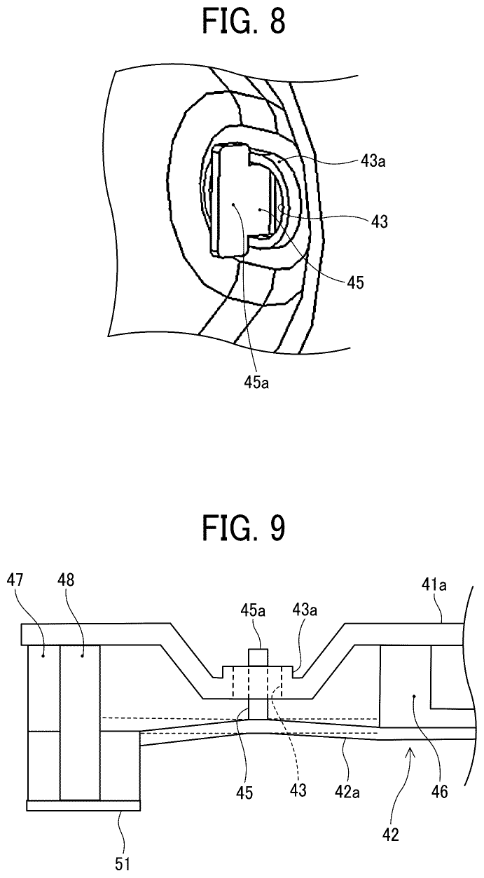

As illustrated in FIG. 4, the holding bracket 42 has a length d from the root of the insertion portion 45 to an abutment face of the inner abutment 45a. As illustrated in FIGS. 7 and 8, the scanner frame 41 has a flange portion 43a around the through hole 43 on the inner face of the front plate 41a. As illustrated in FIG. 8, the abutment face of the inner abutment 45a contacts the tip of the flange portion 43a after the holding bracket 42 is attached to the front plate 41a. As illustrated in FIG. 7, the front plate 41a faces the inner face of the body 42a of the holding bracket 42, and the front plate 41a and the body 42a forms a distance h2 from the inner face of the body 42a to the tip of the flange portion 43a after the holding bracket 42 is attached to the front plate 41a. The length d in FIG. 4 is equal to or shorter than the distance h2 in FIG. 7.

The holding bracket 42 is attached to the front plate 41a of the scanner frame 41 as follows. First, the holding bracket 42 is rotated by 90° counterclockwise from the posture illustrated in FIG. 3, and the inner abutment 45a at the tip of the insertion portion 45 is passed through the through hole 43. At this time, the third outer abutment 48 is located below the front plate 41a, and the first outer abutment 46 is located above the front plate 41a. As a result, the outer abutments 46 and 48 do not face the front plate 41a.

Next, the holding bracket 42 is rotated to be in the posture illustrated in FIG. 3. As a result, the inner abutment 45a abuts against the flange portion 43a that protrudes from the inner face of the front plate 41a and is around the through hole 43 as illustrated in FIG. 8. Rotating the holding bracket 42 by 90° causes the first outer abutment 46 and the third outer abutment 48 to ride on the outer face of the front plate 41a. As a result, the three outer abutments 46, 47, and 48 abut against the outer face of the front plate 41a, and the inner abutment 45a abuts against the flange portion 43a.

As described with reference to FIG. 7, the lengths e, f, and g of the outer abutments 46, 47, and 48 are longer than the distances h1, h3, and h4 from the body 42a of the holding bracket 42 to the outer faces of the front plate 41a against which the outer abutments abut, respectively (that is, e>h1, f>h4, and g>h3). In addition, the length d from the root of the insertion portion 45 to the abutment face of the inner abutment 45a is equal to or shorter than the distance h2 from the inner face of the body 42a of the holding bracket 42 to the tip of the flange portion 43a around the through hole 43. As a result, the first outer abutment 46 and the third outer abutment 48 ride on the outer face of the front plate 41a, and the body 42a of the holding bracket 42 is elastically deformed from the shape indicated by the broken line to the shape indicated by the solid line as illustrated in FIG. 9.

Abutting abutments 45a, 46, 47, and 48 against the front plate 41a increases sliding resistance between the front plate 41a and each of the abutments 45a, 46, 47, and 48, which increases a force required to rotate the holding bracket 42 to the position illustrated in FIG. 3. The holding bracket 42 has the extension portion 50, and the push-in portion 52 is disposed on the end part of the extension portion 50. The above-described structure enables the worker to push the push-in portion 52 and rotate the holding bracket 42 by the principle of leverage.

Specifically, the push-in portion 52 is the point of effort in the leverage, the insertion portion 45 is the fulcrum in the leverage, and an abutment position at which each abutment abuts against the front plate is the point of action in the leverage. The extension portion 50 lengthens a distance from the point of effort in the leverage (the push-in portion 52) to the fulcrum in the leverage (the insertion portion 45), and the distance from the point of effort to the fulcrum is sufficiently longer than a distance from the point of action in the leverage (the abutment position) to the fulcrum in the leverage. In other words, the holding bracket 42 includes the body 42a extending in the longitudinal direction, the push-in portion 52 as the operation portion on one end of the body in the longitudinal direction, the outer abutment as the second abutment at another end of the body in the longitudinal direction, and the insertion portion between the second abutment and the operation portion in the longitudinal direction. The holding bracket has a first distance between the operation portion to the insertion portion in the longitudinal direction and a second distance from the insertion portion to the second abutment shorter than the first distance in the longitudinal direction. The worker pushes the push-in portion 52 of the holding bracket 42 and can easily rotate the holding bracket 42 to set the posture of the holding bracket 42 as illustrated in FIG. 3.

After the holding bracket 42 has the posture illustrated in FIG. 3, a screw is screwed into the screw hole 50a in the end part of the extension portion 50, and the tip of the screw is inserted into the through hole in the front plate 41a. The through hole in the front plate 41a is adjacent to the screw hole 50a so that the screw can be inserted into the through hole. As a result, the holding bracket 42 is attached to the front plate 41a of the scanner frame 41 so as not to be rotatable.

The front plate 41a is sandwiched in the front-back direction by the inner abutment 45a and the three outer abutments 46, 47, and 48 to attach the holding bracket 42 to the front plate 41a. The inner abutment 45a abuts against the front plate 41a, and the three outer abutments 46, 47, and 48 abut against the front plate 41a. As a result, the holding bracket 42 is attached to the scanner frame 41 without rattling in the front-back direction of the image forming apparatus. A friction force between the front plate 41a and each of abutments 45a, 46, 47, and 48 also reduces the rattling of the holding bracket 42 in the lateral direction of the image forming apparatus. Accordingly, the holding bracket 42 can be attached to the scanner frame 41 without the rattling without using a screw, which prevents the quality feeling regarding the image forming apparatus from being poor.

Positioning one of the two abutment positions of the inner abutment 45a within the triangle T formed by connecting the three outer abutments 46, 47, and 48 as illustrated in FIG. 6 enables the abutments 45a, 46, 47, and 48 to be satisfactorily abutted against the front plate 41a. The above-described structure firmly fixes a part of the triangle T of the holding bracket 42 to the front plate 41a. Accordingly, positioning a half or more of the terminal mount 51 within the triangle T prevents the periphery of the terminal mount 51 of the holding bracket 42 from being bent when the USB male terminal of the external device is inserted and removed and enhances the quality feeling of the image forming apparatus.

The above-described structure is different from the structure in which fastening the screw attaches the holding bracket 42 to the front plate 41a of the scanner frame 41. The above-described structure does not form a screw hole in the front plate 41a. As a result, the cutting powder generated during the screw groove processing does not adhere to the optical components inside the scanner frame 41.

The above-described structure has the through hole 43 in the front plate 41a of the scanner frame 41 to attach the holding bracket 42 to the scanner frame 41. Since the through hole 43 is formed by punching or laser processing, cutting powder is not generated. The punching or the laser processing to form the through hole 43 generates punch chips each having a certain size, and the punch chips are easily removed unlike the cutting powder and do not remain after the processing to form the through hole 43. Accordingly, even when the design change is made to form the through hole 43 in the front plate 41a of the scanner frame 41 to add the USB port 60 to the image forming apparatus in mass production, the above-described structure hardly and badly affects the reading quality and prevents great bad affection to the cost and the schedule.

In addition, the manufacturing process to make the screw fastening structure in which the holding bracket 42 is screwed to the scanner frame 41, which is different from the structure in the present embodiment, includes a process forming the through hole 43 in the scanner frame 41, a process forming a screw groove on the inner circumferential surface of the through hole 43, and a process removing cutting powder generated when the screw groove is formed. In contrast, the manufacturing process to make the structure in the present embodiment does not include the process forming the screw groove on the inner circumferential surface of the through hole 43 and the process removing the cutting powder generated when the screw groove is formed. As a result, the number of processes to make the structure in the present embodiment can be reduced as compared with the screw fastening structure, which enables cost reduction.

A modification modified from the present embodiment described above is described below.

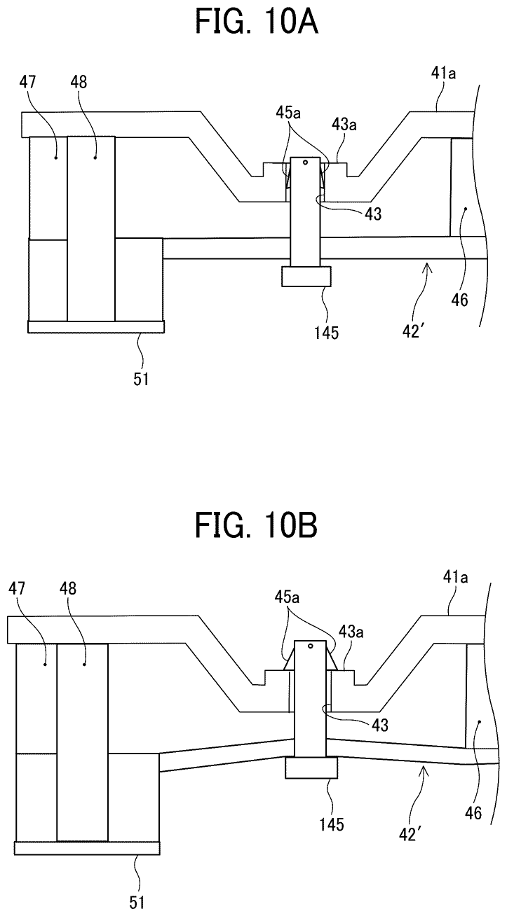

FIGS. 10A and 10B are schematic plan views of a holding bracket 42′ in the modification and a part of the front plate 41a.

As illustrated in FIGS. 10A and 10B, the holding bracket 42′ of the modification does not include the insertion portion, and an insertion pin 145 as a separate member is inserted into the holding bracket 42′.

As illustrated in FIGS. 10A and 10B, the insertion pin 145 includes a pair of inner abutments 45a each formed of a plate-shaped member at the tip of the insertion pin 145. Each inner abutment 45a is swingably attached to the insertion pin 145 and can take a retracted position retracted into the insertion pin 145 and a protruding position protruding from the insertion pin 145. The inner abutment 45a has a tapered portion. When the inner abutment 45a is at the protruding position, the tapered portion inclines outward from the tip of the insertion pin 145. The inner abutment 45a is biased by a biasing member so as to be located at the protruding position.

In this modification, the through hole 43 in the front plate 41a is a round hole.

When the tip of the insertion pin 145 is inserted into the through hole 43, the tapered portion of each inner abutment 45a is pushed by the edge of the through hole 43. As a result, the insertion pin 145 swings from the protruding position to the retracted position, and the tip of the insertion pin 145 is inserted into the through hole 43 as illustrated in FIG. 10A.

Pushing the insertion pin 145 elastically deforms the body 42a of the holding bracket 42. After the tip of the insertion pin 145 passes through the through hole 43, the biasing member swings each of pair of the inner abutments 45a from the retracted position to the protruding position as illustrated in FIG. 10B. As a result, the pair of inner abutments 45a abut against the flange portion 43a around the through hole 43. Similarly to the embodiment, the front plate 41a is sandwiched in the front-back direction by the pair of inner abutments 45a and the three outer abutments 46, 47, and 48 to attach the holding bracket 42 to the front plate 41a.

In the modification illustrated in FIGS. 10A and 10B, the pair of inner abutments 45a are swingably disposed on the insertion pin 145, but each of the pair of inner abutments 45a may be fixed to the insertion pin 145 at the protruding position. In such a configuration, the through hole 43 is formed as a long hole as in the embodiment, and the tip of the insertion pin 145 is passed through the through hole 43 with the protruding direction of the pair of inner abutments aligned with the longitudinal direction of the through hole 43. After the inner abutments 45a pass through the through hole 43, the insertion pin 145 is rotated by 90°. As a result, the pair of inner abutments 45a can abut against the flange portion 43a around the through hole 43.

The above-described embodiments are illustrative and do not limit this disclosure. Thus, numerous additional modifications and variations are possible in light of the above teachings. For example, elements and/or features of different illustrative embodiments may be combined with each other and/or substituted for each other within the scope of this disclosure.

For example, in the above description, the inner abutment abuts against the front plate at two positions, but the inner abutment may abut against the front plate at one position. Further, for example, the inner abutment 45a may have a cross shape protruding from the tip of the insertion portion 45 in four directions of the upward direction, the downward direction, the left direction, and the right direction. After the cross-shaped inner abutment is passed through the cross-shaped through hole 43, the holding bracket may be rotated by 45° to cause the inner abutment to abut against the flange portion around the through hole at four positions.

The holding bracket 42 may include four or more outer abutments. At least one of the abutment positions at which the inner abutments abut against the front plate and at least half or more of the terminal mount are arranged so as to be within a polygonal shape formed by connecting the abutment positions at which the four or more outer abutments abut against the front plate. The above-described structure firmly fixes the periphery of the terminal mount to the front plate.

The configurations according to the above-descried embodiment and the modification are examples, and embodiments of the present disclosure are not limited to the above. For example, the following aspects can achieve effects described below.

### (First Aspect)

In a first aspect, a holding bracket such as the holding bracket 42 is attached to a fixed member such as the scanner frame 41 to hold a connection terminal such as the USB female terminal to connect an external device. The holding bracket includes an insertion portion such as the insertion portion 45, a first abutment such as the inner abutment 45a, and a second abutment such as the outer abutment 46, 47, or 48. The insertion portion is inserted into a through hole such as the through hole 43 of the fixed member. The first abutment is disposed at a tip of the insertion portion and abuts against the fixed member from a direction opposite to an insertion direction in which the insertion portion is inserted into the through hole. The second abutment abuts against the fixed member in the insertion direction. The holding bracket is attached to the fixed member by the first abutment that abuts against the fixed member and the second abutment that abuts against the fixed member.

In the first aspect, abutting the first abutment against the fixed member from the direction opposite to the insertion direction in which the insertion portion is inserted into the through hole and abutting the second abutment against the fixed member from the insertion direction causes the fixed member to be sandwiched by the first abutment and the second abutment, and the holding bracket is attached to the fixed member. As a result, the holding bracket can be attached to the fixed member without rattling in the insertion direction (in other words, an abutting direction in which the abutment is abutted to the fixed member). In addition, a friction force between the fixed member and each of abutments also reduces the rattling of the holding bracket in a direction orthogonal to the insertion direction and enables the holding bracket to be attached to the fixed member. Accordingly, the holding bracket can be attached to the fixed member without rattling and without using a screw.

### (Second Aspect)

In a second aspect, the holding bracket according to the first aspect further includes three or more second abutments such as the outer abutments 46, 47, and 48. When viewed from the insertion direction, an abutment position at which the first abutment such as the inner abutment 45a abuts against the fixed member such as the scanner frame 41 and a half or more of a terminal mount such as the terminal mount 51 to which the connection terminal such as the USB female terminal is attached are positioned within a polygonal shape formed by connecting the abutment positions at which the three or more second abutments abut against the front plate.

According to the second aspect, positioning the abutment position at which the first abutment such as the inner abutment 45a abuts against the fixed member to be within the polygonal shape formed by connecting the abutment positions at which the second abutments abut against the fixed member such as the scanner frame 41 firmly fixes a part of the holding bracket around the polygonal shape to the fixed member such as the scanner frame 41 as described with reference to FIG. 6. Arranging the half or more of the terminal mount such as the terminal mount 51 to which the connection terminal is attached to be within the polygonal shape reduces the deformation of the holding bracket 42 when the terminal of the external device is inserted into and removed from the connection terminal attached to the terminal mount 51, which enhances the quality feeling.

### (Third Aspect)

In a third aspect, the insertion portion such as the insertion portion 45 in the holding bracket according to the first aspect or the second aspect is inserted into the through hole such as the through hole 43 having a long hole shape in the fixed member such as the scanner frame 41. The first abutment such as the inner abutment 45a protrudes from a tip of the insertion portion in a direction orthogonal to the insertion direction. The first abutment is longer than a length of the through hole 43 in a short-side direction of the through hole and shorter than a length of the through hole in a longitudinal direction of the through hole.

According to the third aspect, setting the posture of the holding bracket 42 so that the direction in which the first abutment such as the inner abutment 45a protrudes from the insertion portion 45 is in parallel to the longitudinal direction of the through hole 43 enables the first abutment to pass through the through hole 43 as described in the embodiment. After the first abutment passes through the through hole 43, rotating the holding bracket enables the first abutment to be abutted against the fixed member such as the scanner frame 41.

### (Fourth Aspect)

In a fourth aspect, the holding bracket according to the third aspect further includes an operation portion such as the push-in portion 52 to rotate the holding bracket 42 after the tip of the insertion portion 45 passes through the through hole 43. When viewed from the insertion direction, the distance from the operation portion to the insertion portion 45 is longer than the distance from the insertion portion 45 to each of the abutments 45a, 46, 47, and 48.

As described in the embodiment, the rotation operation of the holding bracket 42 after the tip of the insertion portion 45 is inserted through the through hole 43 requires a large force to overcome the sliding friction between each abutment and the fixed member such as the scanner frame 41.

According to the fourth aspect, lengthening a distance from the push-in portion 52, which is the point of effort in the leverage, to the insertion portion 45, which is the fulcrum in the leverage, to be longer than a distance from the insertion portion 45 to the abutment position on which each of the abutment abuts against the fixed member, which is the point of action in the leverage, enables the holding bracket to be easily rotated during the rotation operation of the holding bracket 42, which enhances the workability to attach the holding bracket to the fixed member.

### (Fifth Aspect)

In a fifth aspect, the body 42a of the holding bracket 42 according to any one of the first to fourth aspects is elastically deformed by the first abutment such as the inner abutment 45a abutting against the fixed member such as the scanner frame 41 and the second abutment such as the outer abutment 46, 47, or 48 abutting against the fixed member.

According to the fifth aspect, as described in the embodiment, each of the abutments 45a, 46, 47, and 48 abuts against the fixed member such as the scanner frame 41 with a strong force, which enables the holding bracket to be firmly attached to the fixed member. Accordingly, the holding bracket can be favorably attached to the fixed member without rattling.

### (Sixth Aspect)

In a sixth aspect, an image forming apparatus includes the holding bracket 42 according to any one of the first to fifth aspects to hold the connection terminal such as the USB female terminal to connect to the external device and the fixed member such as the scanner frame 41 to which the holding bracket 42 is attached.

According to the sixth aspect, the holding bracket can be attached to the fixed member such as the scanner frame 41 without the rattling without using a screw, which enhances the quality feeling regarding the image forming apparatus.

### (Seventh Aspect)

In a seventh aspect, the image forming apparatus according to the sixth aspect further includes a frame such as the scanner frame 41 of the scanner 4, and the frame includes the fixed member to which the holding bracket 42 is attached.

According to the seventh aspect, a screw groove is not formed in the scanner frame. The above-described structure prevents the cutting powder generated while the screw groove is formed from remaining in the frame such as the scanner frame 41 without being removed after the screw groove is formed, adhering to the optical components in the frame, and exerting an adverse effect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A holding bracket comprising:
a terminal mount to which a connection terminal is mounted;
an insertion portion inserted into a through hole of a fixed member in an insertion direction from an outer face to an inner face of the fixed member;
a first abutment disposed at a tip of the insertion portion to abut against the inner face of the fixed member; and
a second abutment to abut against the outer face of the fixed member,
wherein an abutment of the first abutment and the second abutment against the fixed member attaches the holding bracket to the fixed member.

2. The holding bracket according to claim 1, further comprising:
three or more second abutments including the second abutment,
wherein the first abutment has a first portion abutting against the inner face of the fixed member,
the three or more second abutments have second portions abutting against the outer face of the fixed member, and
a half or more region of the terminal mount and the first portion are disposed within a polygonal region formed by connecting positions of the second portions when viewing the outer face of the fixed member from the insertion direction.

3. The holding bracket according to claim 1,
wherein the through hole has a long hole having:
a first length in a longitudinal direction of the long hole; and
a second length in a short-side direction of the long hole, and
the first abutment protrudes from the tip of the insertion portion in a direction orthogonal to the insertion direction, and
the first abutment has a third length shorter than the first length and longer than the second length.

4. The holding bracket according to claim 3, further comprising:
a body, extending in the longitudinal direction, from which the insertion portion and the second abutment protrude in the insertion direction; and
an operation portion, on one end of the body in the longitudinal direction, to rotate the holding bracket when the first abutment is inserted through the through hole,
wherein the second abutment is disposed at another end of the body in the longitudinal direction,
the insertion portion is disposed between the second abutment and the operation portion in the longitudinal direction, and
the holding bracket has:
a first distance from the operation portion to the insertion portion in the longitudinal direction; and
a second distance from the insertion portion to the second abutment shorter than the first distance in the longitudinal direction.

5. The holding bracket according to claim 1, further comprising:
a body from which the insertion portion and the second abutment protrude in the insertion direction,
wherein the body is elastically deformable by the abutment of the first abutment and the second abutment against the fixed member.

6. An image forming apparatus comprising:
the holding bracket according to claim 1 to hold the connection terminal connected to an external device; and
the fixed member to which the holding bracket is attached.

7. The image forming apparatus according to claim 6, further comprising
a scanner with a frame including the fixed member.
